(19) United States
(12) Patent Application Publication
(10) Pub. No.: US 2012/0280049 A1
(43) Pub. Date: Nov. 8, 2012

(54) Personal Health Record (PHR) ID card claiming priority for 61/482624

(76) Inventor: Laurel S. Bennett, Royal Palm Beach, FL (US)

(21) Appl. No.: 13/464,938

(22) Filed: May 4, 2012

Related U.S. Application Data
(60) Provisional application No. 61/482,624, filed on May 5, 2011.

(51) Int. Cl. B42D 15/00; G06K 19/06

(52) U.S. Cl. 235/494; 283/74

(57) ABSTRACT

The invention provides patient emergency or critical healthcare information, such as allergies, medications, diagnosis, doctor and hospital information to emergency healthcare providers, yet this information maintains patient confidentiality through the use of a QR code. The information is unseen or unavailable to the naked eye and is only visible with a specific type of reader or application. The healthcare information, determined by the owner, resides behind or within an image or Quick Reference (QR) code and this image or QR code has to be scanned with a QR reader or application in order for it to be seen. The QR Personal Health Record (PHR) identification card, laminated or not, is about the size of the business card that easily fits into the wallet. Other ways to use this PHR ID card is through a key fob, bracelet, charm, cell phone sleeve, and pendent.

### CROSS REFERENCE TO RELATED APPLICATIONS

Not Applicable

### STATEMENT OF FEDERALLY SPONSORED RESEARCH/DEVELOPMENT

Not Applicable

### REFERENCE TO A “SEQUENCE LISTING,” A TABLE, OR A COMPUTER PROGRAM LISTING APPENDIX

Not Applicable

### FIELD OF INVENTIONS

The present invention generally relates to the field of electronic medical data collection, printing, storing and displaying and in particular, to the customizable, portable identification in particular to personal health or medical identification cards or devices.

### BACKGROUND OF THE INVENTION

Conventional ways to carry around critical medical information, that needs to be accessed quickly and in the case of being unconscious, consist of listing it on a card or pieces of paper and carrying it around. This is cumbersome and patient confidentiality is readily compromised by the information being available to anyone seeing the card or papers at any given point in time. It was not HIPAA compliant as it was viewable to anyone that could read, see it, find it and disclose it. Conventionally or customarily, medical identification (ID) cards are used to display information that identifies the person as well as some part of their medical information, such as their insurance or a diagnosis. They are limited in size and the information shown is available to all who have access to the card or who can read what is on the card and therefore the information is not necessarily confidential or hidden from view.

Additionally, there are USB or Flash drive systems that are used to maintain electronic health records and although they can hold immense data, they can be bulky or bothersome to carry around and they generally have to be read by other systems and are not easily accessed for emergency or critical medical data.

Cards or devices that are easily readable, portable, and customizable and have the emergency medical information readily accessible, yet still hidden from the naked eye are needed. They could provide medical care providers and first responders and emergency medical transporters with critical information such as allergies, medications, diagnosis, name, doctor and hospital information and if the owner has a Personal Health Record (PHR), and the owner desires it, they would be able to link to it.

### BRIEF SUMMARY OF THE INVENTION

The invention solves the problem of keeping critical medical information hidden from the casual observer, onlooker or thief yet makes it readily available to Emergency Medical Teams (EMTs) or first responder(s) or health care providers without having to use a computer or passwords.

In one aspect, it provides customizable, portable medical emergency information that can be carried in a person's wallet, purse, cell phone case, pendent or any other carrying apparatus.

In another aspect, the invention provides a customizable portable identification and can contain a link to the patient's doctor, hospital or PHR.

In yet another aspect, the invention is customizable, portable, yet waterproof, rust resistant and is credit card thin and low profile.

Specifically, the parts of the invention provide a portable, customizable, device that consists of a data stored within or behind the removable printable card member or QR code. More specifically, but not limited to the image can be imprinted with personal identification information such as allergies, medications and diagnosis and/or link to the patient's PHR.

The owner of the card or device decides what critical information will be available to the emergency healthcare providers and that information put on the removable, printable card member.

### BRIEF DESCRIPTION OF THE SEVERAL VIEWS OF THE DRAWING

FIG. 1 is a top view of the present invention drawing showing the customizable, portable identification device for embodiments of the invention and the removable printable card image or QR code in position

FIG. 2 is the backside view of the present invention drawing showing the customizable, portable device for embodiments of the invention.

FIG. 3 is a black and white photo of an example of the front of the card clearly showing the removable printable card image in position and thus, where the medical information would be embedded along with the owner's name and text.

FIG. 4 is a black and white photo of a sample of the back of the card, clearly showing the logo for PHR Solutions and where other logos could be placed as well as stating the web address of the maker of the card.

### DETAILED DESCRIPTION OF THE INVENTION

I want to claim priority of provisional patent 61/482,624.

As required, detailed features and embodiments of the invention are disclosed herein. However, it is to be understood that the disclosed features and embodiments are merely exemplary of the invention that may be embodied in various and alternative forms. The figures are not necessarily to scale, and some features may be exaggerated or minimized to show details of particular components. Therefore, specific structural and functional details disclosed herein, and any particular combination of these details, are not to be interpreted as limiting, but merely as a basis for claims and as a representative basis for teaching one skilled in the art to variously employ the invention.

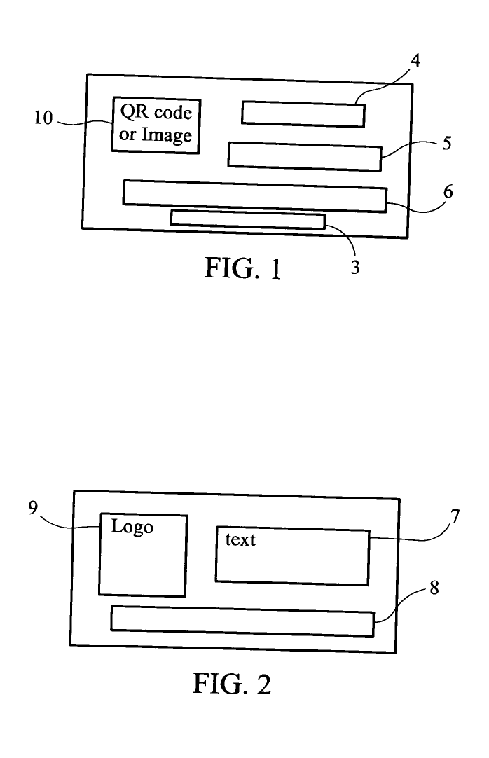

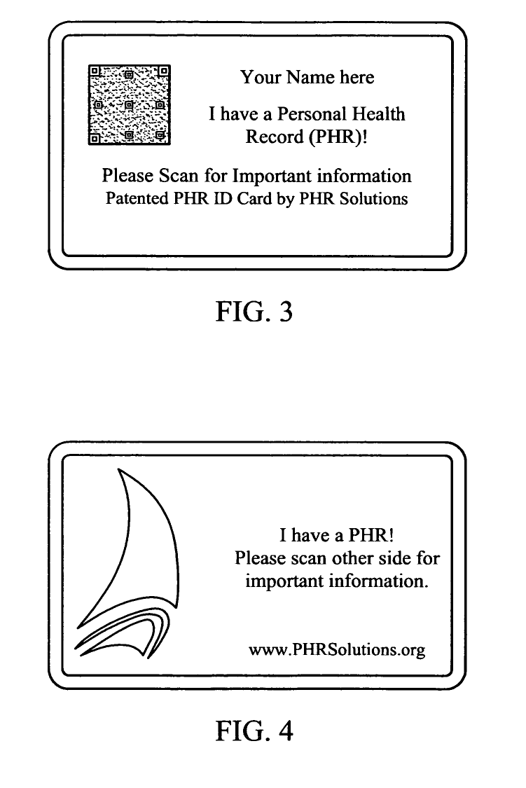

Referring now to the invention in more detail, in FIG. 1 there is a shown identification card having the owner's name and a removable printable card image or code attached to the upper left hand side of the card.

In further detail, still referring to the invention of FIG. 1 the ID card is about the size of the typical business card, ˜3-4 inches long and about ˜2 inches wide. The removable printable card image 10 is on the front of the card and is about 1 inch wide and 1 inch tall as for easy scanning The owner's name 4, and various statements pertaining to the owner having a PHR 5 and the words or similar words stating “Please scan for Important Information” 6 are also on the front of the car followed by the patent number below.

Referring now to the invention in more detail, in FIG. 2 there is a statement of “I have a Personal Health Record (PHR)! Please scan other side for important information” 7 in the center of the card and the web address of the company at the bottom of the card 8. A Logo 9 would be on the left hand side of the card and other logos could be added.

Below are the steps to create the removable printable card member.

For the removable printable card member or QR code, we use a QR code generator to create the QR codes that holds and hides the emergency medical information the owners want us to use. The QR code is clearly defined and published as an ISO standard. Denso Wave owns the patent rights on QR codes, but has chosen not to exercise them. Utilizing the QR capability (a QR code (short for Quick Response) is a specific matrix (or two-dimensional code), readable by dedicated QR readers and applications that can read the QR code such as smart phones and the code consists of black modules arranged in a square pattern on a white background and the information encoded can be text, URL or other data), the health care provider can scan the QR, pull up the hospital and doctor's numbers and see the emergency information (such as being allergic to PCN or being on Coumadin).

We utilized the text option or url option for the QR generator and we enter in the patient's or owner's name, and their emergency information that they want hidden within the QR code. Once the QR image is generated, we add that image to a housing device, such as a business card, along with their name and the statements stating that they have a PHR and to scan for pertinent information”.

The advantages of the present invention include, without limitation, that it is portable and exceedingly easy to use yet keeps the critical medical information easily available to emergency care personnel yet hidden from the general population.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A customizable, portable identification and memory device, comprising: a housing and a removable printable card member;

2. The housing could be comprised of cell phone sleeve, paper, key fob, pendent, bracelet, charm or any carrying apparatus

3. The device according to claim 1, whereas the removable printable card member stores a url or weblink to link to a personal health record (PHR) for the user

4. The device, according to claim 1, the removable printable card member is imprinted with text

5. The device according to claim 1, removable printable card member, is further imprinted with allergies, medications, emergency contact information for the user

6. The device according to claim 1, removable printable card member, is further imprinted with emergency medical information such as diagnosis or emergency contact information for the user and at least one personal item, such as their name

7. The device according to claim 1, removable printable card member, comprises of one printed Quick Reference (QR) code or image
